(19) United States
(12) Patent Application Publication
(10) Pub. No.: US 2023/0112273 A1
(43) Pub. Date: Apr. 13, 2023

(54) Process for Producing an Aroma-Laden Gas, Aroma-Laden Gas, and Use of the Aroma-Laden Gas

(71) Applicant: Döhler GmbH, Darmstadt (DE)

(72) Inventors: Bram HARMSEN, Oberdorf BL (CH); Harald ROSENBLATT, Griesheim (DE); Klaus GÜNTHER, Reinheim (DE)

(73) Assignee: Döhler GmbH, Darmstadt (DE)

(21) Appl. No.: 17/910,778

(22) PCT Filed: Mar. 12, 2021
(86) PCT No.: PCT/EP2021/056305

§ 371 Date: Sep. 9, 2022

(30) Foreign Application Priority Data
Mar. 14, 2020 (DE) 10 2020 001 722.3

(51) Int. Cl. A23L 2/54; A23L 2/56; B01D 11/02

(52) U.S. Cl. CPC A23L 2/54; A23L 2/56; B01D 11/0288; B01D 11/0203; B01D 11/028

(57) ABSTRACT

A process for producing an aroma-laden gas (10) comprises the following steps: a) providing a liquid phase (5), which contains a solvent and one or several aromatic substances (1, 2, 3); b) guiding through a solid phase extraction column (3) of the liquid phase provided in step (a) by obtaining the solid phase (35) laden with one or several aromatic substances; separating one or several aromatic substances from the laden solid phase by means of at least one gas (2) in a liquid and/or supercritical state; and optionally d) collecting the gas (10), which is laden with one or several aromatic substances (1, 2, 3).

### TECHNICAL FIELD

The disclosure relates to a process for producing an aroma-laden gas, an aroma-laden gas, the use of the aroma-laden gas, in particular the use of aroma-laden carbon dioxide, and a process for aromatizing a product.

### BACKGROUND

In the food industry, carbon dioxide (CO₂) is used mostly for the saturation of soft drinks, beer, or mineral water. The population's increasing awareness for a healthy life style promotes the sale of alcohol-free beverages, such as, for example, sparkling wines (champagne), soft drinks, or beers. This requires the search for new production techniques, which make it possible to produce beverages or food, respectively, not only with palatable taste and a pleasant smell, but also completely without the use of ethanol. Such products are of interest, generally as part of a healthier way of life in particular for countries, in which it is required that food is halal according to the religious rules (Halal certificates).

According to the European Food Information Regulation (LMIV), the labeling requirement for alcohol begins only at 1.2 vol. %. The term “alcohol-free” does not inevitably mean “without alcohol”. For example, beer and wine advertised as being “alcohol-free” may contain maximally 0.5 vol. % of alcohol. Should a different beverage (other than wine or beer) be offered as being “alcohol-free”, it may in fact not contain any alcohol at all, the alcohol content is thus 0.0 vol. %, the labelling “alcohol-free” is otherwise considered to be misleading and consumer deception.

The addition of aromatic substances in ethanol as solvent is not possible because the end product does not comply with the term “without alcohol” (alcohol content is thus 0.0 vol. %).

The usual distillation processes for the dealcoholizing of beverages are not suitable because the physical strains associated therewith (such as, e.g., high temperatures or sub-atmospheric pressure) damage the aromatic substances and volatile aromatic substances are lost and thus change the taste of the beverage.

The use of compressed gases, such as CO2 in the supercritical or liquid state, in an extraction (supercritical fluid extraction, SFE in short) of plant material is already known as process (see, for example, EP 0062893 A1 or EP 0397642), in which the ingredients, which are temperature-unstable, odor-active, or otherwise significant for the aroma or the efficacy of the extract, can be extracted in a gentle way at low temperatures.

A supercritical fluid has properties of gas as well as of liquid. In this supercritical state, such a fluid or a gas, respectively, e.g. CO2, acts as solvent. Supercritical carbon dioxide has a density, which is very similar to the density of a liquid, but has the same viscosity as a gas. This thus results in higher diffusion coefficients than in the liquid phase and thus in higher mass transports. It can dissolve or extract materials in a sample.

It is also known that the solid phase extraction, SPE in short, older term also sorbent extraction) is a sample preparation method with regard to a possible enrichment, concentration, or isolation of an analyte. In the solid phase extraction, a liquid phase is extracted on a solid phase (sorbent). The fractionation of a tomato extract using a solid phase extraction is mentioned, e.g., in EP 2844083 B1.

A process for the extraction of two or more fractions from hop oil is described in EP 3063260, in that the hop oil loaded onto an adsorbing carrier is initially treated with liquid carbon dioxide for the purpose of separating the first fraction, and then with supercritical carbon dioxide for the purpose of separating the second fraction. The further fractions can be separated by means of a Co solvent during the combination of the supercritical carbon dioxide.

EP 0062893 A1 discloses a process for producing plant extracts with improved sensory properties. The plant parts are initially extracted, for example with supercritical CO₂. The extracted plant ingredients are then deposited on a powder- or granulate-shaped carrier material. The residues of the plant parts are subjected to a second extraction with water and/or a monohydric C1-C3 alcohol, wherein the obtained extract is dried. The products obtained after the first and second extraction are combined by means of mixing.

### SUMMARY

No known process provides for the production of the aroma-laden carbon dioxide, in which the aromatic substances are enriched from highly diluted starting solutions without heat treatment and are virtually free from any solvent, such as water, ethanol, etc.

There is thus the object of finding an improved process for producing an aroma-laden carbon dioxide, which is suitable for introducing aroma/aroma mixtures into food, cosmetic products and/or pharmaceutical products, which can be labelled “without alcohol”.

A further object is to find a process, which makes it possible to “enrich” the aromatic substances from highly diluted starting solutions (which only contain traces of aromatic substances) in the end product, namely in the aroma-laden gas, and to optionally combine various aroma compositions in the end product.

This object was surprisingly solved by a process for producing an aroma-laden gas, wherein the process comprises the following steps:
(a) providing a liquid phase, which contains a solvent and one or several aromatic substances,
(b) guiding through a solid phase extraction column (SPE column) of the liquid phase provided in step (a) by obtaining the solid phase (sorbent) laden with one or several aromatic substances, step (b) can optionally be repeated,
(c) separating one or several aromatic substance(s) from the laden solid phase by means of at least one gas in the liquid and/or supercritical state, and optionally
(d) collecting the gas, which is laden with one or several aromatic substances.

The process allows for extracting the aromatic substances even from highly diluted, preferably aqueous starting solutions in a concentrated form. First of all, the aromatic substances are adsorbed or concentrated, respectively, on the solid phase of an SPE column, and are transferred with the help of a further extraction with supercritical or/and liquid gas, preferably with supercritical CO₂, into the aroma-laden gas, which can be labelled as being alcohol-free. Gas serves as extraction agent as well as carrier material for the aromatic substances, and can be easily removed from these aromatic substances and optionally recycled.

A further advantage of the present process is that thanks to the concentration of the aromatic substances in the SPE column during the extraction with supercritical and/or liquid gas, much less gas and less energy is used in order to extract the same amount of aromatic substances than during the extraction with supercritical or/and liquid gas directly from a highly diluted starting solution. The process is thus more environmentally friendly and, from an economic aspect, is better optimized than the currently known processes for producing an aromatic substance-containing carbon dioxide.

In addition, no further materials are necessary in order to stabilize the produced product.

In the case of the process, work can be performed in all stages at comparatively low temperatures.

### Step (A)

In the context of the invention, “liquid phase” includes any starting solution, starting emulsion, or starting suspension, which meets the requirements on the sample preparation for SPE. This starting solution, starting emulsion, or starting suspension contains at least one solvent and one or several aromatic substances, which can be of animal as well as of plant origin.

The starting materials for the aromatic substances are selected from the group comprising plants, plant parts (such as, for example, flowers, buds, leaves, stems, blades, barks, roots, tubers, bulbs, rootstocks, fruit, and seeds, for example of nuts, berries, fruit, vegetables, grains, pseudo grains, tobacco and/or spices), animal products (such as, for example, honey, meat, bones and bodily fluids, milk), food and starting material for food. These starting materials can be present, for example, in fresh, cooked, dried, fermented form, or in a form, which is produced to be eaten as food or luxury food.

This includes the following starting materials, which, however, serve only for illustration purposes and which are not to restrict the scope of the present invention: strawberry, apple, raspberry, banana, blueberry, tonka bean, oat, rosemary, ginger, vanilla, beer, wine, coffee, tea, cacao, tobacco, essential oils, etc. The liquid phases, which contain essential oils from natural sources (such as plants), such as, for example, hop aroma, are particularly preferred.

The liquid phase can in particular be a condensate or rinsing water, which accumulates during the processing of fruit or during the production of beverages, such as, for instance, fruit juices, coffee, tea, and beer. The liquid phase can also be a beverage itself, and can be selected, for example, from the group containing fruit juices, coffees, milk, and milk products, teas and beers, as well as mixtures thereof.

The invention in particular makes it possible to extract aromatic substances from waste or bypass streams. It is an advantage of the invention to enrich the aromatic substances, which are concentrated to an extremely low extent in “waste streams” or “side streams” of this type, respectively, via a pre-concentration in the solid phase extraction column at least to the extent that they become extractable. An extraction of waste or bypass streams directly from such a starting material is generally not economically possible due to the concentrations, which are very low there, at least not without the use of ethanol or other organic solvents. An extraction of waste or bypass streams directly from such a starting material is therefore currently not possible in an economic manner and in food quality without the use of ethanol.

The aqueous phases generally contain in the range of from 0.0001 to 1%, often from 0.05 to 0.5% of aromatic substances. This can be illustrated in an exemplary manner on the basis of a juice extraction from apples with the following data:

| | |
|---|---|
| harvest | 300,000 kg fruit (apples) |
| juice extraction | 225,000 kg direct juice from fruit |
| juice concentrate | 37,500 kg juice concentrate |
| production | |
| from evaporation | 187,500 kg condensation water from |
| | direct juice |
| from distillative concentration | 1500 kg condensation water concentrate |
| (aroma recovery/evaporator | 1st stage from condensation water |
| cascade) | |
| unused (lutter water for SPE) | 188,005 kg partially dearomatized |
| | condensation water |
| from distillative concentration | 100 kg condensation water concentrate |
| (SCC) | 2nd stage from condensation water |
| | concentrate 1st stage |
| from distillative concentration | 0.3 kg aromatic oil from condensation |
| (rectification) | water concentrate 2^{nd} stage |

The share of aromatic oil of 0.3 kg based on 100 kg from the 2nd stage is 0.3%. Based on 1500 kg from the 1st stage, it is 0.02%. Based on the non-concentrated total condensate amount of 187,500 kg, it is 0.00016%.

Here, the invention makes it possible to extract aromatic substances from liquids, in particular from beverages, as well as from “waste streams”, such as condensates from evaporators, or from water resulting from freeze-drying, or from rinsing water from the cleaning in large-scale industrial plants. Volatile substances are enriched thereby. They are not fractioned but are extracted as total “aroma portfolio” with respect to the respective starting material. The starting concentration of the aromatic substance is not relevant, the latter can be arbitrarily small. The concentration and extraction of the aromatic substances thereby takes place without an organic enrichment and thus in particular without ethanol.

A further advantage of the invention is that a temperature stressing of the aromatic substances is avoided. The solid phase extraction in step b) is preferably performed at room temperature, in particular without a heat-up from the outside. The separation by means of a gas in liquid or supercritical state in step c) can likewise be performed at relatively low temperatures, for example already at 31° C. in the case of supercritical CO₂.

Due to the pre-concentration of all of the aromatic substances of a starting material in step b), the invention provides for a particularly environmentally friendly extraction of these aromatic substances in step c), which allows for a significant savings of solvent, thus gas in liquid or supercritical state, compared to a pure extraction by means of such a gas.

In the present invention, “aromatic substance” identifies a substance, which causes or modifies smell and taste perceptions. Many plants and in particular also fruit contain fragrances and aromatic substances. They are often alcohols, acids, esters, lactones, aldehydes, ketones, acetals, ketals, ethers, epoxides, as well as the analog sulfur compounds thereof. Oxygen, nitrogen, and sulfur heterocyclic compounds, heteroaromatic compounds (e.g. alkyl pyrazines), amines and amides. Simple or complex saturated and unsaturated aliphatic and cycloaliphatic compounds, aromatic compounds and terpenes, etc.

According to experience, for example, the below-mentioned aromatic substances give positive sensory impressions for humans. The compilation shows at least some components, which, in totality, cause the respective typical taste or smell impression in humans, for the “aroma”, which is in each case mentioned in an exemplary manner:
Strawberry: ethyl butyrate, methyl butyrate, ethyl methyl butyrate-2, methyl capronate, 4-hydroxy-2,5-dimethyl-3(2H)-furanone, methyl cinnamate, 3Z-hexenol, gamma-decalactone,
Raspberry: alpha- and beta-ionone, 2E-hexenal, delta-decalactone, 3Z-hexenol, linalool, geraniol
Apple: 2E-hexenol, 3Z-hexenol, 2E-hexenal, hexanal, ethyl butyrate, ethyl-2-methyl butyrate, beta-damascenone,
Orange: ethyl butyrate, methyl butyrate, ethyl-2-methyl butyrate, octanal, hexanal, linalool, acetaldehyde,
Grapefruit: nootkatone, ethyl butyrate, myrcene, linalool, p-menthenthiol-1,8,
Lemon: citral, geraniol, beta-pinene,
Cherry: benzaldehyde, 2E-hexenol, 2E-hexenal, hexanal, beta-damascenone,
Peach: gamma-decalactone, delta-decalactone, 6-amyl-alpha-pyron, 2E-hexenol, beta-damascenone, linalool oxide,
Banana: 3-methyl butyl butyrate, 3-methyl butyl acetate, hexanal, eugenol
Pear: hexyl acetate, 3-methyl butyl acetate, 2E-hexenyl acetate ethyl-2E,4Z-decadienoate,
Coffee: beta-damascenone, 4-hydroxy-2,5-dimethyl-3(2H)-furanone, furfurylthiol-2, 4-vinylguaiacol, 3-hydroxy-4,5-dimethylfuran-2(5H)-on, isomeric isopropyl methoxy pyrazines, isomeric ethyl dimethyl pyrazines,
Tea: 3Z-Hexenol, indole, methyl jasmonat,3-methyl-2,4-nonandion, jasmine lactone, beta-damascenone, methyl salicylate,
Onion: dipropyl disulfide, dipropyl trisulfide, methyl propyl disulfide,
Meat: 2E,4Z,7Z-tridecatrienal, 2E,5Z-undecadienal, 2E,4Z-decadienal,
Rice: 2-acetyl-1-pyrrolin, octanal, nonanal,
Milk: 1-octen-3-on, diacetyl delta-decalactone, delta-dodecalactone, decanoic acid,
Tomato: 3Z-hexenol, 4-hydroxy-2,5-dimethyl-3(2H)-furanone, beta-damascenone, dimethyl sulfide
Mint: L-menthol, menthone, L-carvone,
Beer: isoamyl acetate, 2-phenyl ethanol, ethyl butyrate, octanoic acid,
Wine: wine lactone, 2-phenyl ethanol, linalool, linalool oxide.
Passionfruit: ethyl hexanoate, linalool, gamma-decalactone, hexyl butyrate, hexyl hexanoate, 3Z-hexenyl butyrate, 3Z-hexenyl hexanoate
Mango: dimethyl sulfide, alpha-pinene, ethyl butyrate, 4-hydroxy-2,5-dimethyl-3(2H)-furanone, gamma-octalactone, gamma-decalactone, 3Z-hexenol
Pineapple: methy-2-methyl butyrate, ethyl-2-methyl butyrate, ethyl hexanoate, methyl-(3-methylthio)propionate, ethyl-(3-methylthio)propionate, 4-hydroxy-2,5-dimethyl-3(2H)-furanone,
Honey: phenyl acetic acid, phenyl acetaldehyde, beta-damascenone
Caramel: 3-hydroxy-4,5-dimethylfuran-2(5H)-on, 4-hydroxy-2,5-dimethyl-3(2H)-furanone, 2-hydroxy-3-methyl-2-cyclopenten-1-on,
Oat: 2-acetyl-1-pyrroline, (E,E,Z)-2,4,6-nonatrienal, vanillin,
Malt: 2-methylbutanal, 3-methylbutanal, 2-acetyl-1-pyrrolin, vanillin, 3-hydroxy-4,5-dimethylfuran-2(5H)-on, isomeric isopropyl methoxypyrazines, isomeric ethyl dimethyl pyrazines.

In addition to the mentioned aroma components, further amounts of mercaptans (thioalcohols) and mono-, di-, tri-sulfides (thioethers), which are relevant from a sensory aspect, can be included.

Any solvent, which is known in the food, cosmetics, or pharmaceutical industry and which is suitable for solid phase extraction, can be used as solvent mentioned in step (a). The solvent is preferably selected from the group, which comprises water, solvents that are miscible with water, in particular polar solvents, and mixtures thereof, as well as mixtures of one or several solvents, that are miscible with water, with water. Saline water is also possible. The polar solvents that are miscible with water can be selected, for example, from the group comprising water, ethanol, propylene glycol, isopropyl alcohol, and the mixtures thereof. Water or aqueous mixtures are particularly preferred as solvents, wherein the water content is at least 90 vol. %. Water is most preferably as solvent.

In the context of the present invention, the liquid phase, which contains water and aqueous mixtures as solvent, is referred to as “aqueous phase”.

In the present process, the lowest concentration, for which the person of skill in the art can assert that the aromatic substances are present in the starting solution, is suitable as “minimum concentration” of the aromatic substances. Broadly speaking, even one substance molecule per liter of the solvent can be sufficient for performing the process. To attain a certain reliability, the minimum concentration, which is considered to be the limit of detection (LOD), can be defined as lower concentration limit for the aromatic substances in the liquid phase. A 3:1 signal-to-noise ratio (signals of the samples containing the analyte in low concentrations, are compared to the signal of a blind sample), is commonly used to estimate the limit of detection. The limits of detection are between 0.5 and 2 ng/l. The analytical methods, which have such a low limit of detection, are, e.g., gas chromatography-mass spectrometry.

### Step (B)

Sorbents (adsorbents) or cartridges filled therewith, which are filled into the SPE column, are referred to as “solid phase”. Nonpolar sorbents are preferably used. A solid phase extraction column, which is suitable for the process, is commonly a column made of glass or stainless steel, wherein the inner volume can commonly lie in the range of a few millimeters up to thousands of liters. For example, polymer materials or silica gels, which are modified hydrophobically for the reverse phase SPE and which are thus nonpolar, fall under the nonpolar sorbents. The crosslinked polymers, typically in the form of resin grains (synthetic adsorber resins) are considered to be suitable. The porous adsorber resin without functional group, which has crosslinked polystyrene as matrix, is preferred.

Polystyrenes, which are crosslinked in various ways, such as, for example, copolymers of ethyl vinyl benzol and divinyl benzol, vinyl pyrrolidone and divinyl benzol, vinyl pyridine and divinyl benzol, styrene and divinyl benzol, but also other polymers, such as, for instance, polyaromatics, polystyrenes, poly(meth)acrylates, polypropylenes, polyesters and/or polytetrafluorethylenes, are examples for adsorption materials, which can be used in the context of the invention.

The “solid phase”, in particular the adsorber resins, which are used at least as part of the solid phase, has or have such a porosity that the specific surface of the solid phase or of the adsorber resin, respectively, which can be determined, for example, according to the BET method, lies in the range of from 500 to 1500 m²/g, particularly in the range of from 700 to 900 m²/g, wherein 800 m²/g is most preferable. Solid phases of this type are commercially available, for example, in the form of adsorber resins.

The pore diameter of such a solid phase or of such adsorber resins, respectively, is up to 10 nm, preferably from 5 to 10 nm.

In step (b), the liquid phase provided in step (a) is transported with pressure through the solid phase extraction column from the top or from the bottom, wherein the aromatic substances from the liquid phase are adsorbed or enriched, respectively, with this sorbent by means of a sorbent in the SPE column.

Step (b) can be performed (or optionally repeated) until the solid phase is completely saturated with aromatic substances and/or the aqueous phase is completely cleaned of aromatic substances, so that the complete aroma spectrum of the aqueous phase can be extracted (exhaustive extraction). This is an advantage compared to fractioning (discriminating) distillative processes.

When selecting the suitable temperature and the pressure for the solid phase extraction according to step (b), it is important to ensure that the liquid phase has the lowest possible viscosity and that the aromatic substances remain stable. The preferred temperature range lies between 4 and 20° C. However, different temperatures are also conceivable (e.g. 0 to 100° C.), if there are technological or physical-chemical necessities for this. This requires a sufficiently high adsorption capacity, which can be ensured in the range of 0 to 60° C.

In general, the adsorber resins, in which, in particular linear, flow speeds of from 0.5 to 50 m/h can be realized, can be used. For a solid phase extraction, the flow speed of the liquid phase is referred to as linear speed. A range of from 5 to 30 m/h, in particular 20 m/h, is preferred for the flow speeds.

After step (b), the solid phase will be laden completely or partially with one or several aromatic substances, so that it can be extracted/eluted by means of a gas in the supercritical and/or liquid state in step (c).

In a preferred embodiment, a step (b1), in which water is guided through a laden SPE column as solvent, takes place after step (b). Such a rinsing with water according to step (b1) is particularly preferred when starting with a solvent, e.g., ethanol, which is unwanted in the end product, in step a). The water can thereby be saline. The rinsing with water can be carried out so that essentially no traces of a solvent, such as ethanol, are present in the end product (aromatized gas, in particular CO₂), so that, in a practical sense, the end product is free from ethanol.

### Step (C)

One or several aromatic substance(s) are separated from the solid phase by means of a gas in liquid and/or supercritical state in step (c).

“Gas in liquid and/or supercritical state” is understood to be a nonpolar, compacted (compressed), or cryogenic liquified gas, which is gaseous at standard conditions (25° C. and 101.3 kPa). “Gas” includes the gas in a pure form as well as in the form of a mixture with another gas and/or a co-solvent, preferably an organic solvent. Carbon dioxide (CO₂) and/or nitrous oxide (N₂O, laughing gas) are preferred. Carbon dioxide in the supercritical state is particularly preferred.

Step (c) is performed either directly in the SPE column or in a device, which is suitable for this purpose.

Should the extraction with supercritical and/or liquid gas, preferably supercritical carbon dioxide, take place directly in the SPE column, the SPE column and all lines leading to this column are constructed in a pressure-resistant manner.

In a preferred embodiment, the gas flows through the SPE column in liquid and/or supercritical state, preferably supercritical CO2, from the bottom to the top in step (c).

An alternative option is to remove the aroma-laden solid phase from the SPE column after step (b), and to transfer it into a device, which is suitable for the extraction with supercritical and/or liquid gas. For example, a column, which has the same or a similar construction as the SPE column in step (b), can be used as device.

To facilitate the removal of the aroma-laden solid phase from the SPE column, the sorbent can be accommodated in the SPE column between two frits in a hose made of an inert material, for example of plastic or stainless steel, or in one or several plastic cartridge(s).

When selecting the suitable temperature and the pressure for step (c), it is important to ensure that gas, preferably CO2, remains in the supercritical or liquid state, respectively, and that the aromatic substances are not negatively impacted.

Step (c) can be performed until an essentially complete separation of the aromatic substances is attained. An aroma-laden gas, which, measured in % by weight, has a concentration of the aromatic substance or of the aromatic substances, which is, for example, up to 2000-times higher, in particular approximately 400-times to approximately 500-times higher, and which contains the starting material in step a), can thus be provided in step c).

Depending on the application, the separation of the aromatic substances can be supported in that aside from the at least one gas in the liquid and/or supercritical state, a solvent, in particular an organic solvent, is used in step c) during the stripping. In particular the above-mentioned solvents mentioned with regard to step a) are suitable solvents. After step c), the solvent can be removed from the aroma-laden gas again in a step cl).

The product extracted in step (c) represents an essentially alcohol-free aroma-laden gas in supercritical or liquid state, respectively.

### Step (D)

The aroma-laden gas can be collected. This can take place, for example, in suitable containers.

In the context of the invention, the collecting of the aroma-laden gas can also take place in that the aroma-laden gas is introduced into a material, in which the aroma is absorbed or dissolved, respectively. This material can be a liquid, in particular a solution, an emulsion and/or a suspension and/or a dispersion of a gas in a liquid, for example a whipped liquid, such as, for instance, cream, or a foam, which is based on another liquid. In the context of the invention, the material can also be an oil, a food ingredient, or a food additive, or even an aroma. The gas extracted in step c) can thereby be used itself for foaming, or the gas is removed during introduction into the respective material, so that only the aroma passes to the material. The material, which comprises the aroma extracted in step c), can be added to the actually intended end product. The material can in particular be selected from the group, which comprises cooking oils, fruit kernel oils, triglycerides, propylene glycol, triacetin, triethyl citrate, aroma carriers, emulsions and slurries, in particular slurries, which are suitable to transfer aromas into a dry form by means of suitable drying processes, for example spray drying. The material can furthermore comprise a solid, which is capable of sorption, such as, for example, plant parts, in particular cereals, seeds, fruit, vegetables.

In a further embodiment, the aroma-laden gas extracted in step c) can also be fed to the further processing without a collecting after performing step c). Should carbon dioxide in the supercritical state be used in step (c), the product in the collecting container is also obtained in a supercritical state.

The aroma-laden gas, in particular aroma-laden carbon dioxide, which was produced according to the process, is virtually solvent-free. The amount of solvent in the aroma-laden gas is maximally 0.05% by volume.

In a preferred embodiment, the aroma can be at least partially separated from the aroma-laden gas, for example after step (c) and/or after step d). In a further development, the at least partial separation of an aromatic substance or of several, in particular all, aromatic substances from the gas from the aroma-laden gas by extracting an aromatic substance or a mixture of aromatic substances is provided for this purpose in a step d1). In addition to the use of the aroma-laden gas, the invention thus also provides for the use of a gas with concentrated extracted aroma or for the use of the extracted aroma alone.

The use of a separating means furthermore provides the advantage of a cost reduction because only the flow resistance of the separating means, for example the osmotic pressure difference of a membrane, has to be overcome to extract the aromatic substances, compared to a relaxation of the aroma-laden gas until the aromatic substance or the aromatic substances precipitate.

The aroma-laden gas can in particular be guided through a membrane filter for the purpose of pressure reduction. The pore size of the membrane filter is selected, for example, so that the gas molecules, preferably CO₂ molecules, which are generally smaller than aromatic substance molecules, are allowed to pass, and the aromatic substances stay behind. Such membrane filters are known, e.g., from “Membrane Technology and Research, Inc.”. The reverse dimensioning of the pore size is also possible, so that the gas molecules are retained at the membrane filter, and the aroma passes through the filter. Aromatic substance molecules can thus be separated from gas molecules by means of a filtration step. Whether the aroma is held back or passes through the filter is thereby dependent on the selection of the filter material, in particular on the membrane selection.

The filtered-out and aromatic substance-free gas can either be released into the atmosphere or can be collected again and can be recycled in the process and can thus be returned into step c).

The aroma-laden gas can also be relaxed in a different way, aside from or in addition to the above-described use of membranes, in order to attain the separation of aromatic substances from the gas. As a result of the pressure drop, the aromatic substances then precipitate, and the separated aromatic substances can be used for the aromatization.

The option is thus created, on the one hand, to use an aroma-laden gas for the aromatization, and, on the other hand, to use the extracted aromatic substances for the aromatization, in particular entirely without gas.

In an embodiment, the product (aroma-containing gas or aroma-laden solid phase) obtained according to the process, is collected in one or several containers or compressed gas containers, respectively, which are suitable for this purpose, and is sold to customers. The containers are selected in particular for aroma-containing gas so that they can withstand pressure of at least 75 bar. Should the pressure in the obtained product be minimized (e.g. after guiding through a membrane filter or after relaxation), other containers (which are suitable for a lower pressure) can also be used. The aroma-containing gas is dosed, for example, from a container via one or several dosing valves (e.g. controlled magnetic valves or pneumatic valves), which are preferably controlled, during the production of an aromatized food, luxury food, oral hygiene product, semi-finished product, cosmetic product, or pharmaceutical product.

Thanks to the process, a product is produced, which was not subjected to a thermal processing/stressing/straining (cold extraction—thus approx. room temperature, up to max. 40° C.).

The produced product additionally has a very good microbiological stability because in particular a CO₂ atmosphere prevents the growth of many different microorganisms.

The invention furthermore provides an aroma-laden gas, preferably carbon dioxide, which can be produced in particular according to the above-described process. The invention additionally provides an aroma-laden solid phase, which can be produced in particular according to the above-described process. The solid phase could be used, for example, for the production of aromatized beverages, such as, for instance, in a “soda stream”, or in a drinking device, which detaches aromatic substances from the solid phase by means of air stream when drinking, and feeds them in a retro nasal manner to the consumer, such as, for example, products of the brand “air-up” ®.

The invention thus creates an aroma-laden gas or an aroma-laden solid phase, which, compared to a liquid phase containing a solvent and one or several aromatic substances, has essentially the same composition of aromatic substances and preferably also the same relative shares of aromatic substances. The aroma profile of a starting material is thus maintained. This is advantageous in particular when the liquid phase is selected from the group, which comprises beverages, in particular fruit juices, coffees, milk and milk products, teas and beers as well as mixtures thereof, at least one condensate, rinsing water, at least one secondary stream and/or side stream and/or waste stream from the processing of animal or plant starting materials, for example fruits, or from the production of food, for example beverages, and at least one bypass stream from the processing of fruits, or from the production of beverages, as well as mixtures of at least two of the mentioned liquids.

In particular during the processing of natural raw materials, aromas are combined with one another in a complex way. Substances acting as aromas, which cannot be detected as individual component in the mixture, can be partially contained thereby. The invention accesses the natural composition of aroma profiles of this type and allows in a simple way to transfer said aroma profiles into an end product so as to be largely unaltered by the processing. This is a particular advantage compared to fractioning (discriminating) distillative processes or processes, which separate aromatic substances from aqueous phases according to the size of the aroma molecules.

In the context of the invention, the aroma-laden gas or the aroma-laden solid phase can, for example, contain at least the above-mentioned aromas in the same relative shares as the liquid phase, compared to a liquid phase, which is based on strawberry, raspberry, apple, orange, grapefruit, cherry, peach, banana, pear, black currant, coffee, tea, onion, meat, rice, milk, tomato, mint, beer, wine, passion fruit, mango, pineapple, honey, caramel, oat, malt. In the context of the invention, the aroma-laden gas or the aroma-laden solid phase can contain aromatic substances, which completely reproduce the aroma profile of the starting material. That is, can be perceived in particular by a person of skill in the art as typical aroma profile of the starting material or be present in a composition, which contains a complementary aroma portion of the starting material and can thus be used for the re-aromatization of the starting material, thus for recovery of the organoleptic properties of the starting material prior to the separation from aroma-laden bypass or waste streams.

The process for aromatizing goods of all types can also comprise a step, in which the goods are brought into contact with an aroma-containing gas in a packaging or a container. The aroma-laden gas, in particular carbon dioxide, which is obtained as part of the process, can be guided, for example, through a solution, which is provided for the aromatization (the gas or the CO₂, respectively, only serves as aromatic substance carrier and escapes at least partially from the product during the or after the guide-through) or, when using CO₂ as bubbling gas, can be used to carbonize beverages (whereby CO₂ as well as the aromatic substances are added to the end product).

A fluid, preferably a gas, for example CO₂, can also be guided through an aroma-laden solid phase for aromatizing a product, and can then be introduced into the product.

In a preferred embodiment, the aroma-laden carbon dioxide, which is laden with aromatic substances, which are contained, for example, in a beer starting solution, can be bubbled by means of an alcohol-free beer, in order to change and/or to supplement and/or to recover or to intensify the aroma profile thereof.

The invention furthermore provides a process for aromatizing a product, which is in particular a food, luxury food, oral hygiene product, semi-finished product, cosmetic product, or pharmaceutical product, in the case of which at least one above-described aroma-laden gas and/or at least one aromatic substance separated from the aroma-laden gas is brought into contact with the product, so that at least one aromatic substance passes at least partially into the product and/or into the packaging of the product.

A liquid product, in particular a beverage or an oral hygiene product, can, for example, be aromatized particularly easily by means of the process, in that at least one aroma-laden gas is introduced into the liquid product.

In an embodiment of the aromatizing process, the gas remains at least partially in the product. The product can thus be carbonized with CO₂ as gas, or cream, cremes, frappes, or fruit purees, or similar products can be whipped, so that they contain gas bubbles.

It is provided in a further embodiment that the gas escapes or is removed from the product prior to the use as intended. The aroma for products, which are packaged under protective gas atmosphere, can be provided, for example, in a protective gas. During the storage period, the aroma passes into the product or the packaging, or remains at least partially in the gas phase, and the remaining aroma-laden gas escapes when opening a corresponding packaging. In the alternative, the gas can be removed from the product and can then optionally be used or added as gas in step c) of the process for producing an aroma-laden gas.

The invention also provides the option that at least two aroma-laden gases, which differ in number, relative shares, concentration and/or type of the aromatic substances, are brought into contact with the product. An aroma profile can be set in the product in this way. Depending on the application, the gases can thereby be mixed prior to the introduction into the product. In the alternative, the gases can be brought into contact with the product one after the other or simultaneously, so that the mixing of the aromatic substances takes place in the product.

The invention is to be described on the basis of the enclosed figures, but without being limited to the specially described embodiment. The invention also refers to all combinations of preferred designs, provided that they are not mutually exclusive. The designation “approximately” or approx.” in combination with a figure mean that values, which are higher or lower by at least 10%, or values, which are higher or lower by 5%, and values, which are at least higher or lower by 1%, are included.

### BRIEF DESCRIPTION OF THE DRAWINGS

FIG. 1 shows a flowchart of the process for producing an aroma-laden gas with alternatives for various embodiments,

FIG. 2A shows a schematic illustration for performing step b),

FIG. 2B shows a schematic illustration for performing step c),

FIG. 2C shows a schematic illustration for the use of the aroma-laden gas extracted in step c) in a first embodiment,

FIG. 2D shows a schematic illustration for performing step d),

FIG. 2E shows a schematic illustration for performing step d1),

FIG. 3 shows a schematic illustration for performing a process for producing an aroma-laden gas in a first embodiment,

FIG. 4 shows a basic diagram of a first preferred embodiment of the process for producing an aroma-laden carbon dioxide,

FIG. 5 shows a schematic illustration for performing a process for producing an aroma-laden gas in a second embodiment,

FIG. 6 shows a schematic illustration for performing a process for producing an aroma-laden gas in a third embodiment

FIG. 7 shows a schematic illustration for performing the process for producing an aroma-laden gas in a further embodiment,

FIG. 8A shows a schematic illustration for performing step b) in a further embodiment,

FIG. 8B shows a schematic illustration for performing step c) in a further embodiment,

FIG. 9 shows a basic diagram of a further preferred embodiment of the process for producing an aroma-laden carbon dioxide, in which step (c) is performed in a device, which is suitable for this purpose,

FIG. 10 shows a schematic illustration for performing step c) in a further embodiment,

FIG. 11 shows a schematic illustration for performing step c) in a further embodiment.

### DETAILED DESCRIPTION

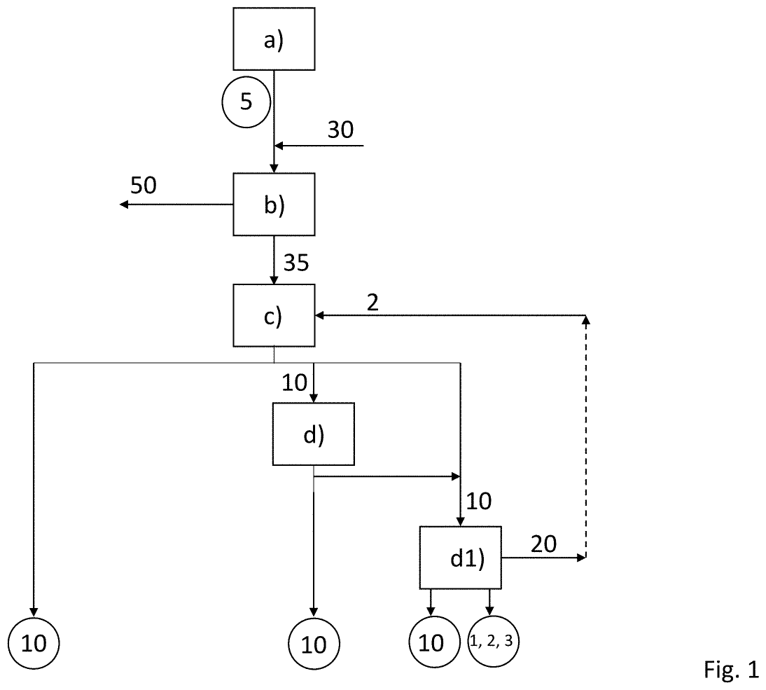

In a flowchart, FIG. 1 shows an overview of various exemplary embodiments of a process for producing an aroma-laden gas. In step a), a liquid phase 5 is provided, which contains a solvent and one or several aromatic substances 1, 2, 3. They are guided through a solid phase extraction column in step b). For this purpose, an adsorber material 30 is provided, which comes into contact with the liquid phase 5. As a result of guiding the liquid phase 5 provided in step a) through the solid phase 30, a solid phase 35 is obtained, which is laden with one or several aromatic substances. In step c), the one aromatic substance is or several aromatic substances 1, 2, 3 are separated from the laden solid phase 35 by means of at least one gas 2 in a liquid or supercritical state. An aroma-laden gas 10 is thus obtained.

The aroma-laden gas 10 from step c) can optionally be subjected to a step d), in which a collecting of the gas 10, which is laden with one or several romantic substances, is performed.

The aroma-laden gas can furthermore be subjected to a step d1), in which an at least partial separation of an aromatic substance or of several, in particular of all, aromatic substances 1, 2, 3 from the gas by extracting an aromatic substance or a mixture of aromatic substances takes place. Either a gas 10, which is enriched with aromatic substance or aromatic substances, or an essentially gas-free aroma or an essentially gas-free mixture of aromatic substances, respectively, is thus created.

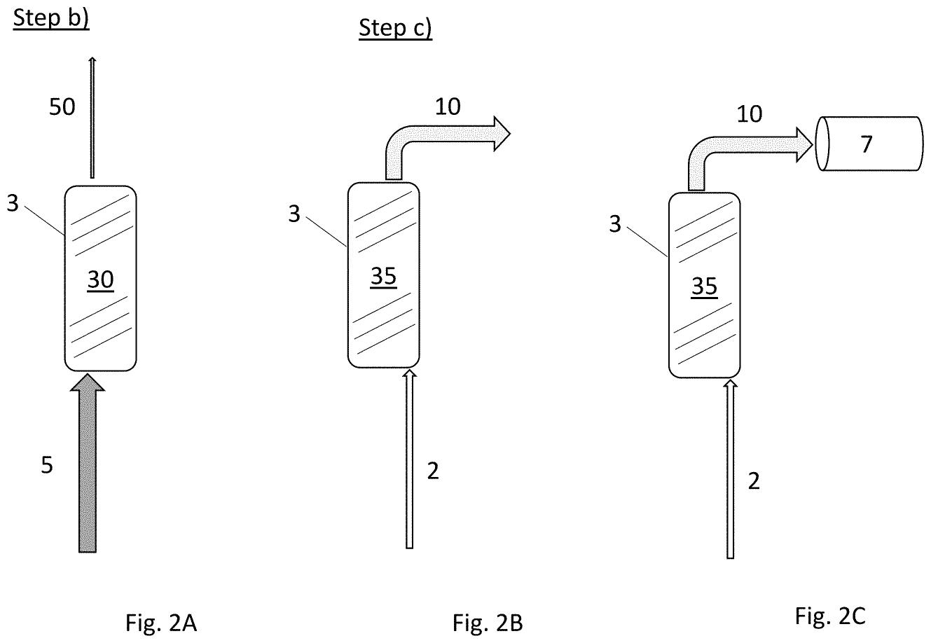

The embodiments illustrated in FIGS. 2A to 11 for performing the steps of processes for producing an aroma-laden gas can be combined to form one embodiment for the specific application. For the selection and the combination of the process steps, the person of skill in the art applies criteria, for example, which comprise location and amount of the resulting starting material, location, amount, and structure of the desired product, space requirement of corresponding plants, and options for the optimization of the plant capacity.

Step b) is illustrated in FIG. 2A. An adsorber material, which is not laden with aromas at the onset of the guide-through of the aroma-containing liquid 5, forms the solid phase 30. As solid phase 30, for example a microporous adsorber resin without functional group, such as “Lewatit® VP OC 1064 MD PH”, can be used.

The solid phase 30 is provided in a solid phase extraction column 3. The liquid 5 is guided through it. FIG. 2A shows the state of the column at the beginning of the performance of step b). Aromatic substances thereby accumulate on the adsorber material, so that an aroma-laden solid phase 35 results (see FIGS. 2B and 2C).

After flowing through the solid phase extraction column 3, the liquid leaves the column 3. The liquid 50 is thereby depleted of aromatic substances, compared to the liquid 5, which flows into the column 3. In particular, the liquid 50 is essentially free from aromatic substances.

On principle, step c) is illustrated in FIG. 2B. Various embodiments provide options for how the aroma-laden solid phase 35 is provided, and will be described in more detail below. In step c), at least one gas 2 in a liquid and/or supercritical state generally flows through the aroma-laden solid phase 35. Aromatic substances thereby desorb from the aroma-laden solid phase 35 into the gas, which is loaded with aromas, and leaves the column 3 as aroma-laden gas 10.

According to the illustration in FIG. 2C, the direct introduction into a product 7 is possible according to an embodiment after the separation of the aromatic substance or of several aromatic substances from the laden solid phase 35 by means of at least one gas 2 in a liquid or supercritical state (see FIG. 2B). The gas can remain there and serves, for example, for foaming or for cooperating with a protective gas atmosphere, or the gas can escape from the product, so that the aroma, which is introduced into the product by means of the gas, remains there and aromatizes the product.

According to the illustration in FIG. 2D, the aroma-laden gas 10 is collected after the separation of the aromatic substance or of several aromatic substances from the laden solid phase 35 by means of at least one gas 2 in a liquid or supercritical state (see FIG. 2B) according to a further embodiment.

A container 8, into which the aroma-laden gas 10 is introduced and remains there, is provided, for example, for this purpose. The container 8 can be uncoupled from the feeding of aroma-laden gas in particular after reaching the desired fill amount, and can be stored, for example, in a closed manner until the aroma-laden gas 10 is used to aromatize a product.

In a further development, the aroma-laden gas can pass through a separating means 6, in which an aromatic substance or several, in particular all, aromatic substances are separated from the gas from the aroma-laden gas by extracting an aromatic substance or a mixture of aromatic substances in a step d1). An example for an embodiment of this type of step d1) is illustrated in FIG. 2E. The aroma-laden gas 10 is provided in a container 8 here. In the context of the invention, it is also possible, however, to feed the aroma-laden gas to step d1) immediately after performing step c) (see FIG. 2B), without collecting it beforehand.

In the embodiment shown in FIG. 2E, a separating means 6 is connected to the container 8. This connection can comprise a transport line, which is arranged between a gas outlet of the container 8 and an inlet of the separating means 6. After passing through the separating means 6, an aroma-depleted gas 20 passes through the separating means. The aroma-depleted gas 20 is preferably essentially free from aromatic substances. The aromatic substances are enriched in the separating means 6 and can be stripped in order to aromatize a product.

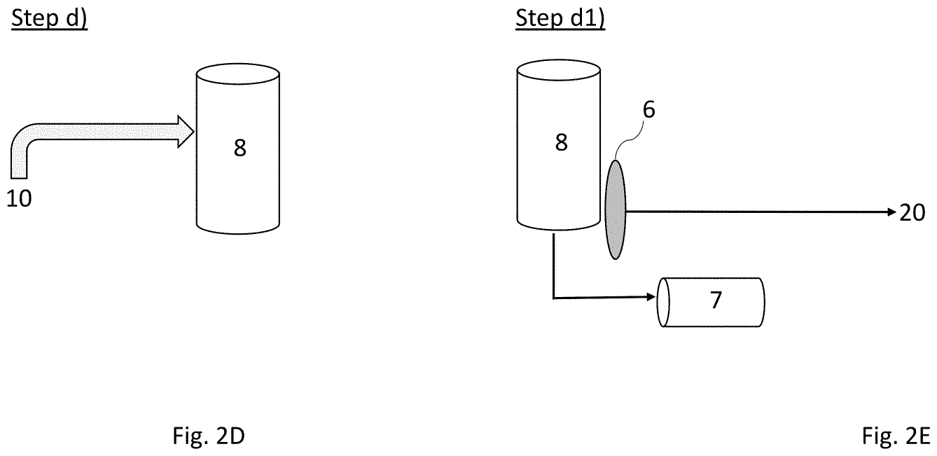

In an arrangement according to FIG. 3, a plant for carrying out the process for producing an aroma-laden gas comprises a solid phase extraction column 3 and a container 8. Both are connected to one another via at least one transport line (not illustrated) for aroma-laden gas. The column 3 has at least connections for the introduction of a liquid 5 and the removal of a liquid 50 as well as for the introduction of a gas 2 and the removal of an aroma-laden gas 10. The transport line can be connected to the connection for the removal of an aroma-laden gas 10. The transport line can furthermore be connected to a connection of the container 8 for the introduction of aroma-laden gas 10. The connections are preferably provided with valves, which can be set, in particular regulated, and allow for or prevent the flow-through of liquid 5, 50 or gas 2, 10, respectively.

In an embodiment, the guide-through of an aroma-laden liquid phase 5 through the solid phase extraction column 3 can take place first in an arrangement according to FIG. 3, wherein aromatic substances are adsorbed on the adsorber filling thereof, and the liquid 50 leaves the column 3. Gas 2 can then be guided through the column, and leaves the latter as aroma-laden gas 10. In the illustrated embodiment, the aroma-laden gas 10 is introduced from the container 8 into a product 7. However, the aroma-laden gas 10 can also be collected in a container 8 according to the corresponding illustration, for example in FIGS. 2D and 2E, before it is used to aromatize a product.

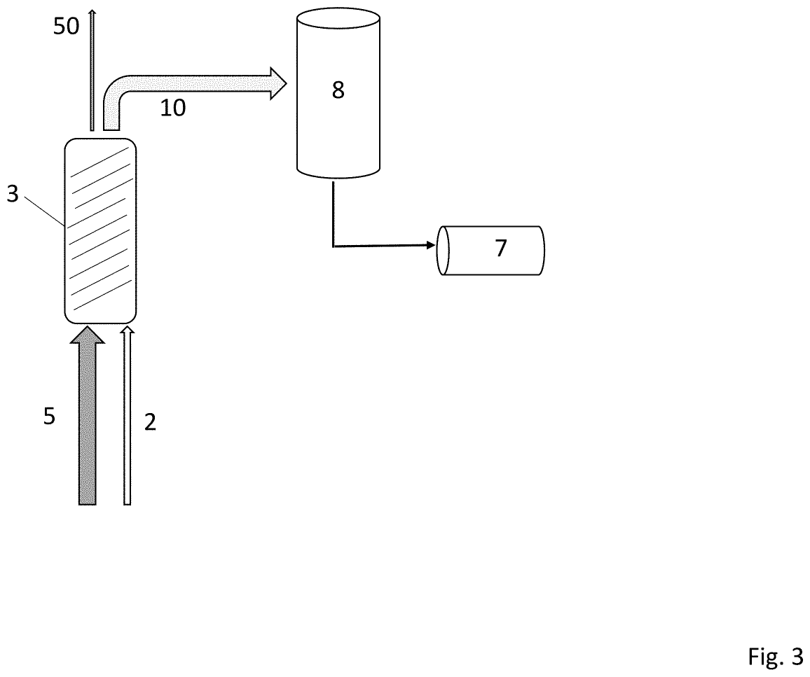

The basic diagram of a preferred embodiment of the process is illustrated in FIG. 4, in which step (c) is performed directly in the solid phase extraction column. The liquid phase and gas are guided through the SPE column from the bottom to the top.

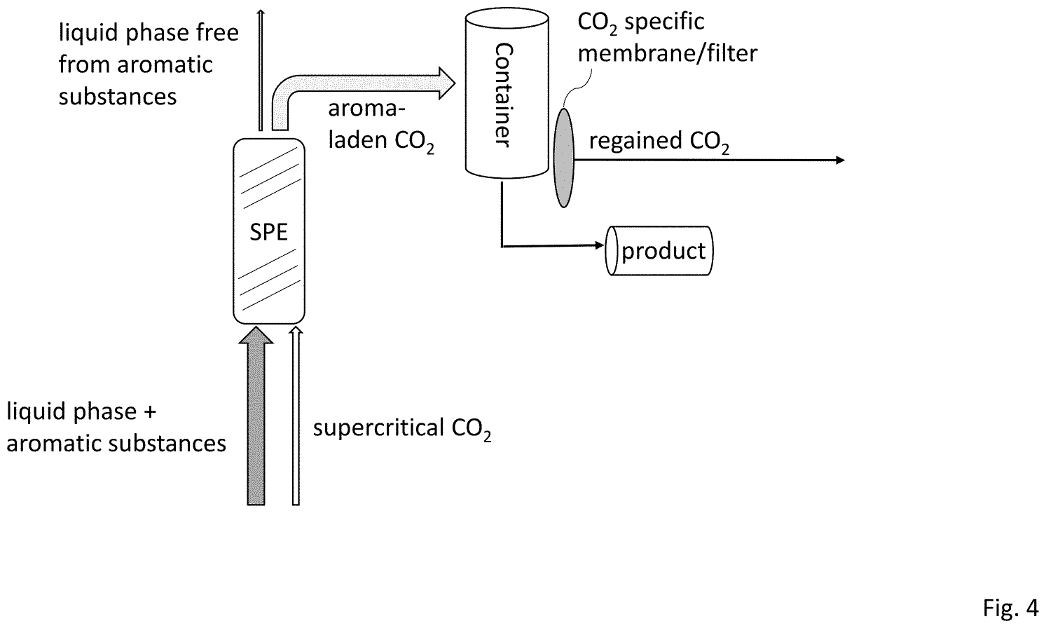

In the shown embodiment, the aroma-laden gas 10 formed thereby is transferred into a container 8 and is guided via a separating means 6. In the shown embodiment, aromatic substances are held back by the separating means, in particular in the container 8. After passing through the separating means 6, an aroma-depleted gas 20 leaves the separating means. It can be reused as gas 2, which is used to strip aromatic substances from the laden solid phase 35. Depending on conditions of the specific application, the gas 20 can be purified and/or temperature-controlled and/or compressed or relaxed, respectively, prior to being reused as gas 2. A dashed line is delineated in FIG. 5 for the recycling of the gas 20 from the separating means 6.

In the context of the invention, it is also possible to use a separating means, which holds back the gas and which allows the aromatic substances to pass. The further use of the aromatic substances and of the gas are maintained thereby.

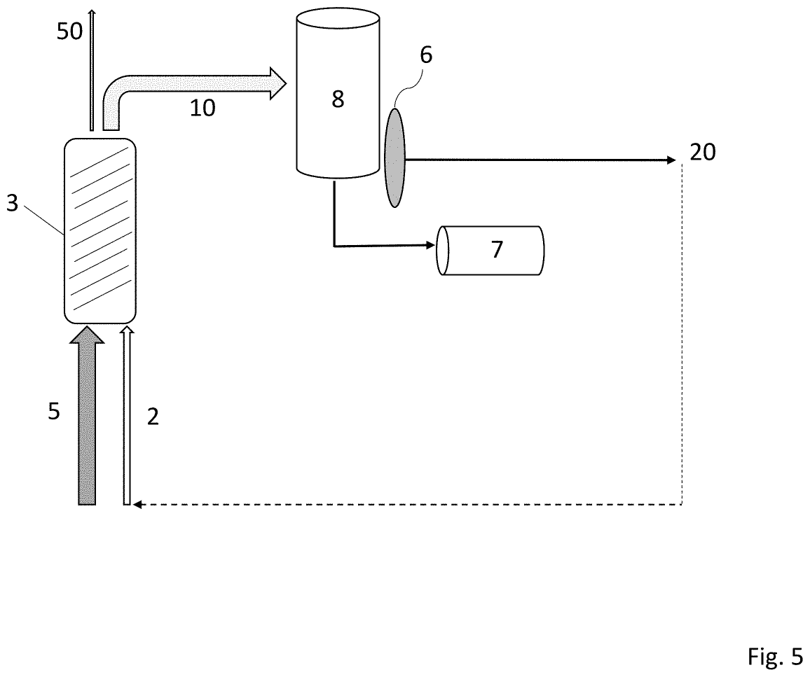

Depending on the type of product 7 and the structure and setup of the product, a product 7 itself can serve as “separating means” 6, as is shown in FIG. 6, in the sense that the aromatic substances from the gas 10 are integrated into the product and the gas 20 escapes from the product. This gas 20 can be collected, this gas can, for example, also be fed to step c) again as part of a recycling. This return for the reuse is suggested by means of a dashed line in FIG. 6.

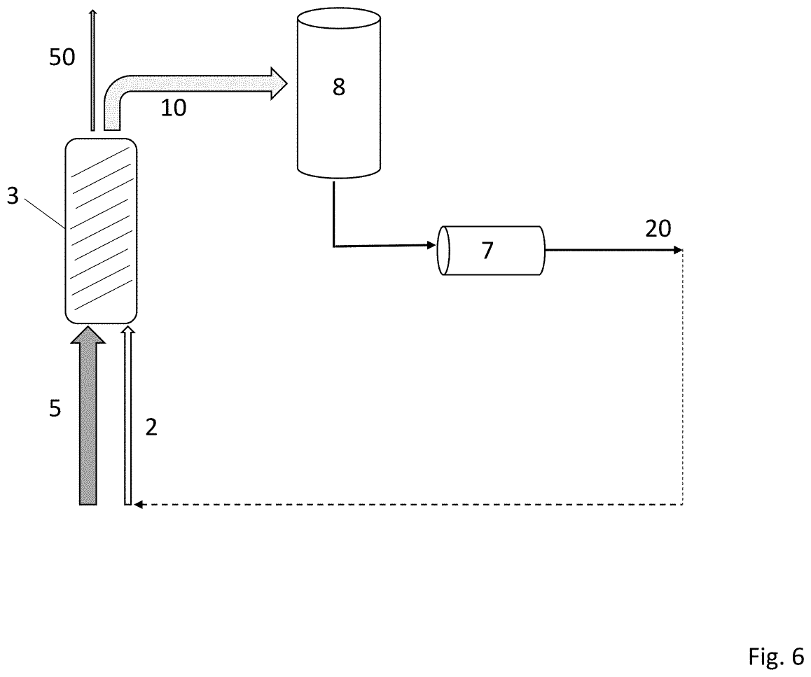

According to the illustration in FIG. 7, steps b) of the solid phase extraction (SPE) and c) of the supercritical fluid extraction (SFE) can be performed in the same adsorber column 3 as described above one after the other, but generally also simultaneously. The gas 2, which absorbs the aromatic substances and leaves the column 3 as aroma-laden gas 10, is then also guided through while guiding the starting material 5 through the column 3.

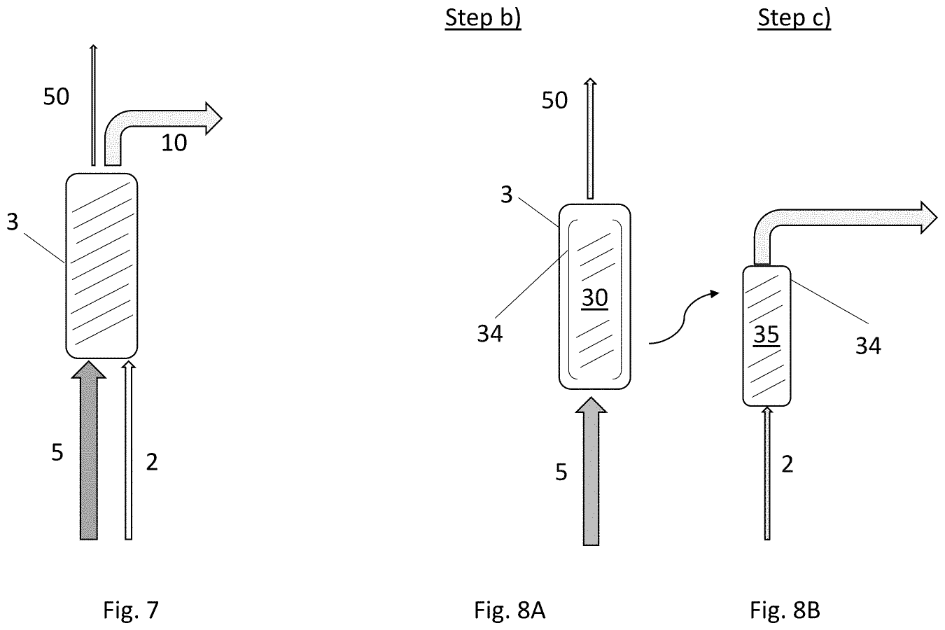

FIGS. 8A and 8B illustrate an embodiment, in the case of which step c) is performed in a device, which is suitable for this purpose, wherein the laden solid phase 35 obtained in step b) is removed from the solid phase extraction column 3 and is transferred into this device.

For this purpose, the adsorber material can be provided in particular in a separate packaging, which allows for a simple handling of the adsorber fill. A receptacle 34 is provided, for example, for this purpose.

The receptacle 34 is designed to receive 30 and/or 35 and can be detachably positioned in the solid phase extraction column 3 in such a way that at least steps b) and c) can be performed during operation, wherein the receptacle 34 is inserted in the SPE column 3, and the starting liquid 5 or the gas 2, respectively, flows through (aroma-laden) absorber arranged therein.

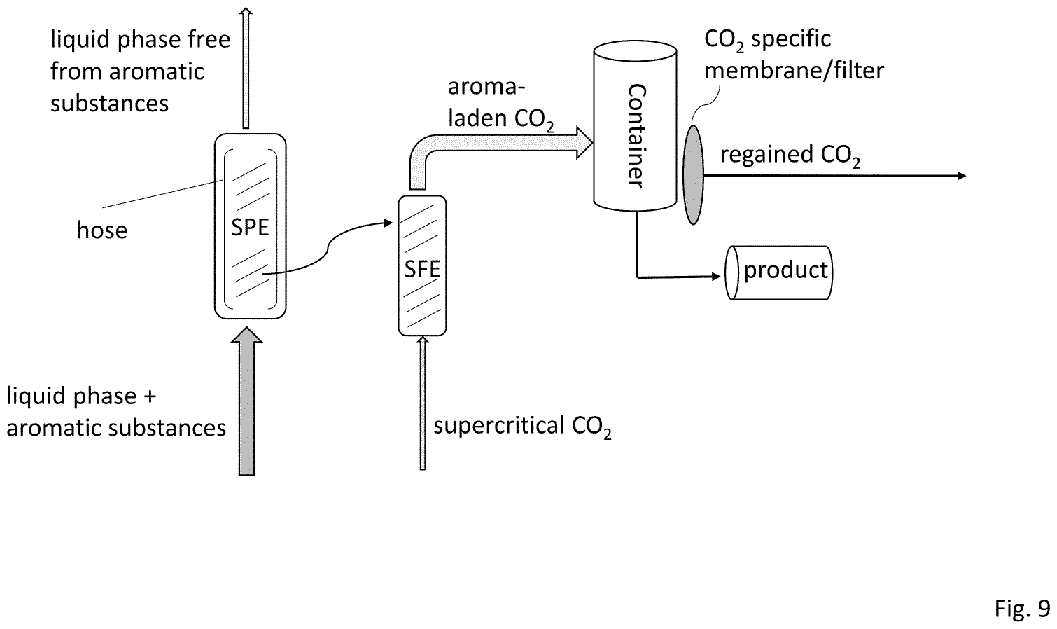

In the simplest case, this device can be formed by means of the receptacle 34 itself, as shown in FIG. 9. In the embodiment shown there, the receptacle 34 is formed as hose.

The basic diagram of a further preferred embodiment of the process is illustrated in FIG. 9, in which step (c) is performed in a device, which is suitable for this purpose, wherein the laden solid phase obtained in step (b) is removed from the solid phase extraction column and is transferred into this device.

In order to facilitate the removal of the aroma-laden solid phase from the SPE column, the sorbent can be accommodated in the SPE column between two frits in a hose made of an inert material, for example of plastic or stainless steel, or in one or several plastic cartridges.

The removal of the solid phase from the solid phase extraction column and the transfer into a different device is thus made possible in a simple way.

Such a container, preferably made as hose in a simple way, has in particular at least one connection for introducing gas 2 and a connection for discharging aroma-laden gas 10.

In a further embodiment, a hose-like container 34 can be inserted into a device (not separately illustrated in FIGS. 8A, 8B, and 9), which has connections for the detachable fastening of a container 34 and the introduction of gas 2 as well as the discharge of aroma-laden gas 10.

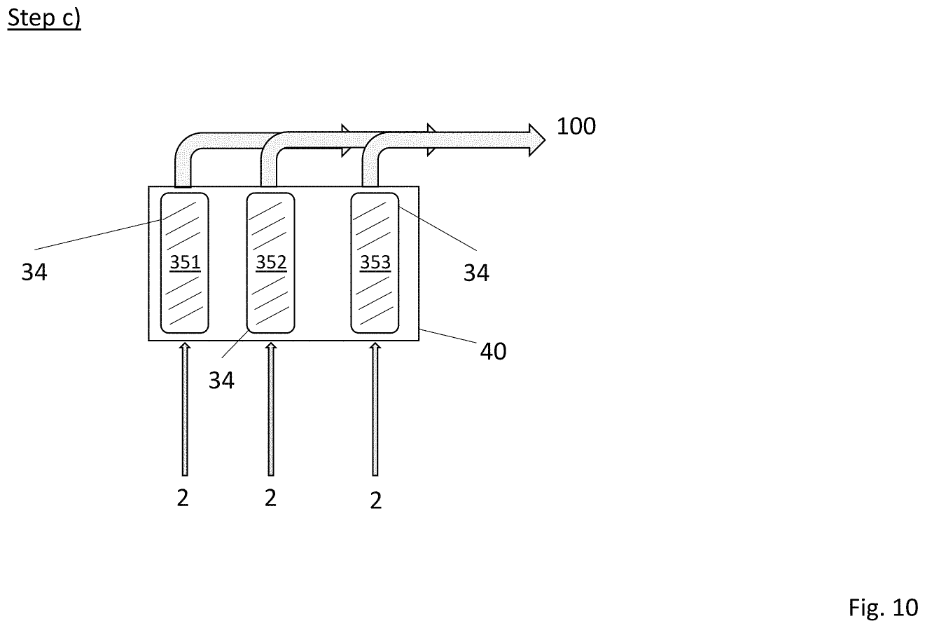

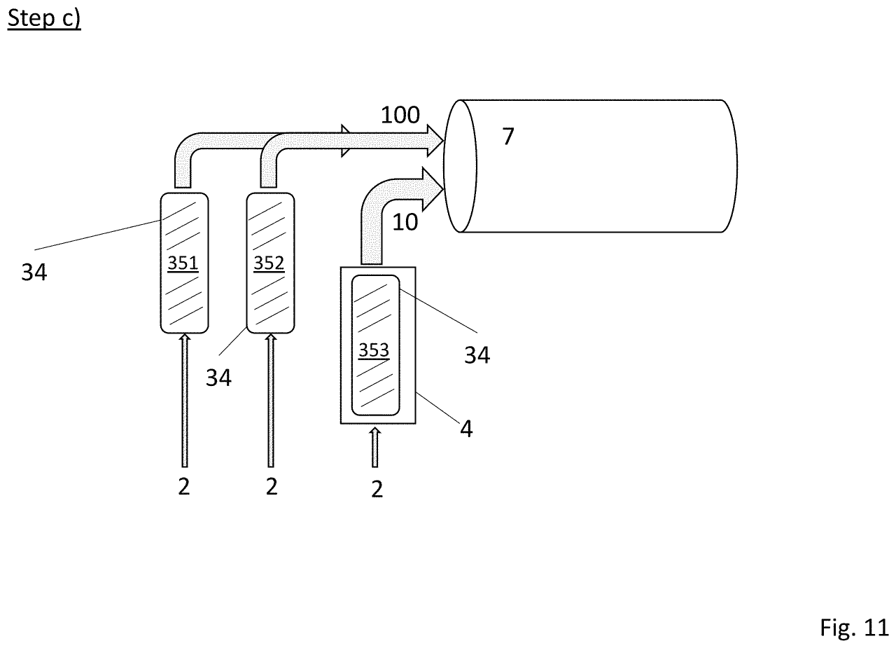

A container 34 inserted into such a device 4 is illustrated in FIG. 11 for the example of a solid phase 353, which is laden with an aroma 3. The device can also be formed to receive several containers 34, one such device 40 is illustrated in FIG. 10 for the example of three solid phases 351, 352, and 353, which are in each case laden with aromas 1, 2, or 3, respectively.

After performing step c), the process is continued according to the above- and below-described options. Aroma-laden gas can also be introduced directly into a produce from a container 34 as “hose”.

The device 4; 40 serves to receive the receptacle 34 and the connection thereof for performing step c). In its design, the device 4; 40 corresponds, for example on principle, to a solid phase extraction column, and is therefore designed in a pressure-resistant manner for step c).

In the context of the invention, the receptacle 34 can also be designed in such a way that step c) can be performed directly by using the receptacles 34. The process is carried out without the use of a device 4; 40 in this case.

Embodiments are illustrated in FIGS. 10 and 11, in the case of which a gas 100, which is laden with an aroma mixture, is produced. In a first exemplary further development, the gas 100 contains an aroma mixture 123 of the aromas 1, 2, and 3, which were removed from the correspondingly laden solid phases 351, 352, and 353. Step c) can in particular be performed at the point of use of the aroma mixture. The aroma mixture is thereby generated by means of combining the aromas 1, 2, and 3, which are individually extracted from the laden solid phases 351, 352, and 353. The process is further continued according to one of the above-described options. The aroma mixture can, as such or provided in the gas 100, in particular be introduced directly into a product or can be collected.

A further option for aromatizing a product with a mixture of aromatic substances 1, 2, and 3 is illustrated in FIG. 11. For this purpose, a gas 100 laden with a first mixture of aromatic substances 1, 2, and a gas 10 laden with a further aromatic substance 3 is introduced into a product 7. The product 7 then contains aroma mixture 123.

The gas 100 and the gas 10 can be introduced into the product so as to overlap in time or one after the other, the aromatization can in particular also be performed at separate locations by means of several, here two, different gases. The gas 100 contains an aroma mixture of the aromas 1 and 2, which were stripped from the correspondingly laden solid phases 351, 352. In this embodiment, the gas 100 is generated by mixing the gases, which are laden with one aromatic substance 1, 2 each. For example, a mixture of the aromatic substances 1 and 2 can be produced first, and the aroma 3 can be extracted separately. The correspondingly laden adsorber material 353 is used in a casing 34 in a connecting device 4.

### Exemplary Embodiment 1

For test purposes, a beer was used as starting solution, which was diluted with water. On principle, any dilutions can be used, for example a dilution by the factor 1:4. In the exemplary embodiment, the beer was diluted with water by the factor 1:20.

According to step b) of the process, this starting solution was guided through an SPE column. This solid phase extraction column was laden with the adsorber resin LEWATIT® VP OC 1064. This adsorber resin is a crosslinked polystyrene with pore diameters according to manufacturer information of between 5 and 10 nm and a specific surface BET 800 m²/g.

An SPE column with a length of approx. 0.5 m and an inner diameter of approx. 20 cm was used. The flow speed during the guide-through of the diluted beer is calculated and set on the basis of the inner diameter of the column and the specification of the adsorber resin. The total amount of the liquid, which is to be guided through, until the absorption capacity of the adsorber resin is depleted, depends on the concentration of the aromatic substances in the starting product. Based on his experience, the person of skill in the art can estimate a possible amount, and then determines the exact maximum capacity by means of tests.

The laden solid phase, thus the adsorber resin laden with aromatic substances from the diluted beer, was removed from the SPE column and was temporarily stored in a vacuum bag.

As step c), the adsorber resin laden with aromatic substances from the beer was subjected to an extraction with supercritical CO2. The composition of the aromatic substance composition in the laden solid phase was eluted with ethanol and was examined. In the context of measuring inaccuracies, the concentration of aromatic substances in the ethanol corresponds to the concentration in the CO₂. The beer had an aroma mixture comprising essentially 2-phenylethyl alcohol, octanoic acid, 3-methyl-1-butanol, 2-methyl-1-butanol, hexanoic acid, 3-methylbutyl-acetate, decanoic acid, isobutanol, octanoic acid ethyl ester and ethyl acetate. The composition of these aromatic substances in the laden solid phase resulted from this as follows:

| Aromatic substance | Ppm | %% by weight | Log P |
|---|---|---|---|
| 2-phenylethyl alcohol | 1772 | 0.39048899 | 1.36 |
| octanoic acid | 1232.6 | 0.27162344 | 2.9 |
| 3-methyl-1-butanol | 806.2 | 0.17765927 | 1.22 |
| 2-methyl-1-butanol | 297.1 | 0.06547081 | 1.22 |
| hexanoic acid | 201.3 | 0.04435973 | 1.84 |
| 3-methylbutyl acetate | 68.9 | 0.01518323 | 2.12 |
| decanoic acid | 51 | 0.01123868 | 3.96 |
| isobutanol | 47.2 | 0.01040129 | 0.69 |
| octanoic acid ethyl ester | 31.5 | 0.00694154 | 3.9 |
| ethyl acetate | 30.1 | 0.00663302 | 0.71 |

The aroma-laden gas obtained by means of the extraction with supercritical CO₂ has a typical “smell of beer”.

### Exemplary Embodiment 2

A CO₂ laden with beer aromas according to Exemplary Embodiment 1 was produced. According to step d1) of the process, the aromatic substances were then separated from the CO₂ extract stream via a high-pressure membrane as separating means.

It was thus possible to separate the aromatic substances from the aroma-laden CO₂ and to enrich them, namely at pressures in the range of between approximately 130 bar to approximately 160 bar, and a temperature in the range of from approximately 60° C. to approximately 14° C., preferably at a temperature of approx. 70° C. when using a membrane made of “Teflon® AF2400”.

### Exemplary Embodiment 3

A CO₂ laden with beer aromas according to Exemplary Embodiment 1 was produced, and the aromatic substances were separated from the CO₂ extract stream via a high-pressure membrane as separating means according to step d1) of the process. The CO₂, which was thus filtered off and which is aromatic substance-free, was then recycled for performing step c) of the solid phase extraction.

The person of skill in the art can see that the invention is not limited to the above-described examples, but, on the contrary, can be varied in a variety of ways. The features of the individually illustrated examples can in particular also be combined with one another or can be exchanged with one another

### LIST OF REFERENCE NUMERALS

1, 2, 3 aromatic substance
123 mixture of aromatic substances
10; 100 aroma-laden gas
2 gas, in particular gas in the liquid or supercritical state; CO2
20 essentially aromatic substance-free gas; gas after passing through a separating step d1); recovered gas
3 solid phase extraction column; SPE column
30 solid phase in the essentially unladen state
34 receptacle or container for receiving 30 and/or 35
35 solid phase laden with aromatic substance or aromatic substances
4; 40 connecting device for receiving 34 for performing step c)
5 liquid phase; starting material; condensate, rinsing water, secondary stream, side stream, waste stream, or bypass stream from the processing of fruit or from the production of beverages
50 liquid depleted of aromatic substances
6 separating means; filter; membrane; CO2-specific membrane; CO2-specific filter
7 product
8 container

1.-20. (canceled)

21. A process for producing an aroma-laden gas (10), comprising the following steps:
a) providing a liquid phase (5), which contains a solvent and one or several aromatic substances (1, 2, 3);
b) guiding the liquid phase (5) provided in step (a) through a solid phase extraction column (3) filled with a solid phase (30) and thereby obtaining a solid phase (35) laden with one or several aromatic substances; and
c) separating an aromatic substance or several aromatic substances (1, 2, 3) from the laden solid phase (35) by a gas (2) in a liquid and/or supercritical state,
wherein the solid phase (30) filled in the solid phase extraction column (3) is or comprises a nonpolar sorbent, which is based on hydrophobically modified polymer materials and/or silica gels, and
wherein a concentration and extraction of the aromatic substance or the several aromatic substances takes place in an ethanol-free manner.

22. The process according to claim 21,
wherein after step (c), a step
d) collecting an aroma-laden gas (10), which is laden with one or several aromatic substances,
is performed.

23. The process according to claim 21,
wherein step (c) is performed directly in the solid phase extraction column (3).

24. The process according to claim 21,
wherein step (c) is performed in a device (4; 40), which is suitable for this purpose, and
wherein the laden solid phase (35) obtained in step (b) is removed from the solid phase extraction column (3) and is transferred into this device (4; 40).

25. The process according to claim 21,
wherein the solvent is selected from the group consisting of water, solvents that are miscible with water, and mixtures of water with one or several solvents that are miscible with water.

26. The process according to claim 21,
wherein the solid phase (30) filled in the solid phase extraction column (3) is or comprises a nonpolar sorbent, which is based on crosslinked polystyrenes as hydrophobically modified polymer materials.

27. The process according to claim 21,
wherein the solid phase is laden completely or partially with one or several aromatic substances (1, 2, 3) in step (b).

28. The process according to claim 21,
wherein the gas (2) is carbon dioxide (CO₂).

29. The process according to claim 21,
wherein the gas (2) is carbon dioxide (CO₂) in a supercritical state.

30. The process according to claim 21,
wherein before or after step (d), a step
(d1) separation of an aromatic substance or of several aromatic substances (1, 2, 3) from the gas from the aroma-laden gas (10) by extracting an aromatic substance (1, 2, 3) or a mixture of aromatic substances (123)
takes place.

31. The process according to claim 30,
wherein a guide-through of the aroma-laden gas (10) through a membrane filter (6) takes place in step (d1), and
wherein a filtered-off and aromatic substance-free gas (20) is optionally recycled.

32. The process according to claim 30 with the further step of
aromatizing a food, pharmaceutical, oral hygiene or cosmetic product (7),
wherein an aromatic substance (1, 2, 3), which is separated from the aroma-laden gas, is brought into contact with the product (7), so that at least one aromatic substance passes at least partially into the product and/or a packaging of the product.

33. The process according to claim 32,
wherein the product (7) is a beverage or an oral hygiene liquid product, and
wherein the aroma-laden gas (10) is introduced into the liquid product (7).

34. The process according to claim 32,
wherein the gas (20) from the aroma-laden gas (10) remains at least partially in the product (7).

35. The process according to claim 32,
wherein the gas (20) escapes or is removed from the product (7) prior to the product (7) being used as intended.

36. The process according to claim 32,
wherein at least two aroma-laden gases, which differ in number, relative shares, concentration and/or type of the aromatic substances, are brought into contact with the product.

37. An aroma-laden gas (10) or aroma-laden solid phase (35), produced according to the process according to claim 21 at a temperature of maximally 40° C.,
wherein
compared to a liquid phase (5) containing a solvent and one or several aromatic substances (1, 2, 3), it has essentially the same composition of and preferably also the same relative shares of aromatic substances (1, 2, 3),
wherein the liquid phase (5) is selected from the group consisting of beverages, fruit juices, coffees, milk and milk products, teas, beers, condensate, rinsing water, a secondary stream and/or side stream and/or waste stream from processing of animal or plant starting materials, or from the production of food, a bypass stream from the processing of fruits, or from the production of beverages, and mixtures thereof, and,
compared to a liquid phase (5) based on at least one below-mentioned fruit or based on at least one below-mentioned starting material, respectively,
the aroma-lade gas (10) or the aroma-laden solid phase (35)
contains at least one of the below-mentioned respective aromas (1, 2, 3) in the same relative shares as the liquid phase:
Strawberry: ethyl butyrate, methyl butyrate, ethyl methyl butyrate-2, methyl capronate, 4-hydroxy-2,5-dimethyl-3(2H)-furanone, methyl cinnamate, 3Z-hexenol, gamma-decalactone,
Raspberry: alpha- and beta-ionone, 2E-hexenal, delta-decalactone, 3Z-hexenol, linalool, geraniol
Apple: 2E-hexenol, 3Z-hexenol, 2E-hexenal, hexanal, ethyl butyrate, ethyl-2-methyl butyrate, beta-damascenone,
Orange: ethyl butyrate, methyl butyrate, ethyl-2-methyl butyrate, octanal, hexanal, linalool, acetaldehyde,
Grapefruit: nootkatone, ethyl butyrate, myrcene, linalool, p-menthenthiol-1,8,
Lemon: citral, geraniol, beta-pinene,
Cherry: benzaldehyde, 2E-hexenol, 2E-hexenal, hexanal, beta-damascenone,
Peach: gamma-decalactone, delta-decalactone, 6-amyl-alpha-pyron, 2E-hexenol, beta-damascenone, linalool oxide,
Banana: 3-methyl butyl butyrate, 3-methyl butyl acetate, hexanal, eugenol
Pear: hexyl acetate, 3-methyl butyl acetate, 2E-hexenyl acetate ethyl-2E,4Z-decadienoate,
Coffee: beta-damascenone, 4-hydroxy-2,5-dimethyl-3(2H)-furanone, furfurylthiol-2, 4-vinylguaiacol, 3-hydroxy-4,5-dimethylfuran-2(5H)-on, isomeric isopropyl methoxy pyrazines, isomeric ethyl dimethyl pyrazines,
Tea: 3Z-Hexenol, indole, methyl jasmonat,3-methyl-2,4-nonandion, jasmine lactone, beta-damascenone, methyl salicylate,
Onion: dipropyl disulfide, dipropyl trisulfide, methyl propyl disulfide,
Meat: 2E,4Z,7Z-tridecatrienal, 2E,5Z-undecadienal, 2E,4Z-decadienal,
Rice: 2-acetyl-1-pyrrolin, octanal, nonanal,
Milk: 1-octen-3-on, diacetyl delta-decalactone, delta-dodecalactone, decanoic acid,
Tomato: 3Z-hexenol, 4-hydroxy-2,5-dimethyl-3(2H)-furanone, beta-damascenone, dimethyl sulfide
Mint: L-menthol, menthone, L-carvone,
Beer: isoamyl acetate, 2-phenyl ethanol, ethyl butyrate, octanoic acid,
Wine: wine lactone, 2-phenyl ethanol, linalool, linalool oxide.
Passionfruit: ethyl hexanoate, linalool, gamma-decalactone, hexyl butyrate, hexyl hexanoate, 3Z-hexenyl butyrate, 3Z-hexenyl hexanoate
Mango: dimethyl sulfide, alpha-pinene, ethyl butyrate, 4-hydroxy-2,5-dimethyl-3(2H)-furanone, gamma-octalactone, gamma-decalactone, 3Z-hexenol
Pineapple: methy-2-methyl butyrate, ethyl-2-methyl butyrate, ethyl hexanoate, methyl-(3-methylthio)propionate, ethyl-(3-methylthio)propionate, 4-hydroxy-2,5-dimethyl-3(2H)-furanone,
Honey: phenyl acetic acid, phenyl acetaldehyde, beta-damascenone
Caramel: 3-hydroxy-4,5-dimethylfuran-2(5H)-on, 4-hydroxy-2,5-dimethyl-3(2H)-furanone, 2-hydroxy-3-methyl-2-cyclopenten-1-on,
Oat: 2-acetyl-1-pyrroline, (E,E,Z)-2,4,6-nonatrienal, vanillin,
Malt: 2-methylbutanal, 3-methylbutanal, 2-acetyl-1-pyrrolin, vanillin, 3-hydroxy-4,5-dimethylfuran-2(5H)-on, isomeric isopropyl methoxypyrazines, isomeric ethyl dimethyl pyrazines,
wherein further amounts of mercaptans (thioalcohols) and mono-, di-, tri-sulfides (thioethers), which are relevant from a sensory aspect, can be included in addition to the mentioned aromatic substance components.

38. The aroma-laden gas (10) produced according to the process according to claim 21,
wherein the gas is carbon dioxide, and
wherein the aroma-laden gas is produced at a temperature of 40° C. or less.
